(19) United States
(12) Patent Application Publication
(10) Pub. No.: US 2004/0263120 A1
(43) Pub. Date: Dec. 30, 2004

(54) System for charging a plurality of remote computers charging and synchronization system for multiple remote computers

(76) Inventors: Henry L. Kazecki, Arlington Heights, IL (US); Steven H. Goode, Barrington, IL (US); James C. Baker, Crystal Lake, IL (US)

Correspondence Address: DONALD G. FLAYNIK, JR., CHERSKOV & FLAYNIK, SUITE 1447, 20 N. WACKER DR, CHICAGO, IL, 60606, US

(21) Appl. No.: 10/877,658

(22) Filed: Jun. 26, 2004

Related U.S. Application Data
(60) Provisional application No. 60/482,811, filed on Jun. 26, 2003.

(51) Int. Cl. H02J 7/00

(52) U.S. Cl. 320/116

(57) ABSTRACT

The present invention is a system 10 for charging a plurality of remote computers that includes a plurality of switch members 12, each switch member 12 being connected to a predetermined quantity of remote computers via power lines 21 such that each switch member 12 has substantially the same quantity of remote computers connected thereto, a charge bank select member 13 for sequentially connecting each of the switch members 12 to a battery charger 18 such that the battery charger 18 simultaneously charges all remote computers connected to the switch member 12 that is connected to the battery charger 18, and a timer 20 that sets the time period that each switch member 12 is connected to the battery charger 18.

The present invention is also a charging and synchronizing system 100 for multiple remote computers that includes the above charging system being coupled to a synchronizing system that includes a universal serial bus (“USB”) select member 104 that selects a USB that is connected to a USB multiplexer (MUX), each USB being connected to a remote computer, the MUX ultimately connecting the selected remote computer to a primary computer whereby the selected remote computer is capable of communicating with the primary computer, a hot-sync select member 107 that initiates communication between each remote computer and the primary computer, and a timer 101 member that cooperates with the USB select member 104 to direct the hot-sync select member 107, via a switch member 105, to select a remote computer (while being charged) to communicate and synchronize with the primary computer.

This application is based on U.S. Provisional Application No. 60/482,811 filed on Jun. 26, 2003.

### BACKGROUND OF THE INVENTION

1. Field of the Invention

The present invention relates to a charging system for a plurality of remote computers and more particularly, to a charging and synchronization systems for multiple remote computers.

2. Background of the Prior Art

Battery chargers for rechargeable batteries used in remote computers or other handheld computer devices, and the objective of limiting the time to charge the rechargeable batteries are well known. A problem occurs when a battery charger is sized for an initial quantity of remote or handheld computers as with a school classroom, then the number of students and the number of remote computers increases to a quantity that exceeds the charging capacity of the original battery charger. The problem is ultimately solved by buying a larger battery charger. A need exists for a system that divides the increasing number of remote computers into smaller groups of substantially equal quantities of remote computers that can be sequentially charged by a battery charger having a charging capacity that satisfies the power demand of the group with the greatest number of remote computers.

Remote or handheld computers not only need charging, but also must be able to communicate with a primary or desktop computer to ultimately download the data from the remote to the primary computer thereby “backing-up” or “back-up synchronizing” or “synchronize” the remote computer to a desktop. As the quantity of remote computers increases, it becomes increasingly difficult to charge all the remote computers, then synchronize the remote computers with the primary computer in a time period that begins at the end of one work or school day and ends at the beginning of the following work or school day.

A need exists for a charging and synchronizing system for multiple remote computers that simultaneously charges and synchronizes each remote computer within a preset time frame whereby all remote computers are ultimately charged and synchronized during a time span during which all the remote computers are inactive.

### SUMMARY OF THE INVENTION

It is an object of the present invention is to overcome may of the disadvantages associated with charging multiple remote computers.

A principle object of the present invention is to provide a system that charges a plurality of remote computers. A feature of the system is the dividing of the remote computers into substantially equal groups or “banks” and the connecting of each group to a power switch. Another feature of the system is a charge bank select member that promotes the sequential connecting of each power switch to a battery charger. Another feature of the system is the simultaneous charging of all remote computers connected to a power switch that is connected to the battery charger. An advantage of the system is that the maximum charging capacity of a power supply can be reduced to correspond to the group of remote computers having the largest power demand. Another advantage of the system is that the size and the cost of the battery charger are reduced. Another advantage of the system is that the total time required to charge all remote computers sequentially is reduced to the time required to charge sequentially all groups of remote computers.

Another object of the present invention is to provide a system that cycles through the groups of remote computers in one hour intervals. A feature of the system is a timer member. An advantage of the system is that each group of remote computers is charged for a set time period thereby promoting the charging of all remote computer groups within a predetermined time period.

Yet another object of the present invention is to provide a system that includes back-up synchronization to a primary or desktop computer. A feature of the system is a universal serial bus (“USB”) select member that receives output signals from the charge bank select and timer members to enable the USB select member to provide an output signal to a USB multiplexer (“MUX”) member to select a USB that is connected to the MUX member and a remote computer. An advantage of the system is that the USB select member promotes (via the MUX member) the connection of a remote computer to a primary computer to allow the selected remote computer and the primary computer to communicate thereby downloading the remote computers data base into the primary computer (back-up synchronization). Another advantage of the system is that the USB select member, based upon information provided by the charge bank select member, ultimately selects (via a hot-sync select member) a remote computer for back-up synchronization that is being charged thereby simultaneously charging and back-up synchronizing a selected remote computer.

Another object of the present invention is to provide a system that controls the back-up synchronization time period. A feature of the system is a handheld DC power switches member that receives signals from the timer and USB select members to provide a signal to a hot-sync select member that is independently connected to each remote computer; the hot-sync select member ultimately “turning on” sequentially each remote computer. An advantage of the system is that the time period for each remote computer can be set to allow each remote computer, in a group of remote computers being charged, to be sequentially back-up synchronized such that when all remote computers in the group have been charged, all remote computers in the group have also been back-up synchronized thereby accomplishing two objectives at the same time.

Briefly, the invention provides a system for charging a plurality of remote computers comprising a plurality of switching means, each switching means connected to a predetermined quantity of remote computers such that each switching means has substantially the same quantity of remote computers connected thereto; means for sequentially connecting each of said switching means to a battery charger such that the battery charger simultaneously charges all remote computers connected to the switching means that is connected to said battery charger; and means for controlling the period of time that each switching means is connected to said battery charger.

Further, the invention provides a charging and synchronizing system for multiple remote computers comprising means for selecting for charging a plurality of remote computers; means for charging said plurality of remote computers; means for selecting one of a plurality of universal serial buses, each of said plurality of universal serial buses being connected to a remote computer; means for connecting said one selected universal serial bus to a primary computer whereby a selected remote computer connected to said selected universal serial bus is capable of communicating with the primary computer; means for initiating communication between the selected remote computer and the primary computer; and means for promoting the communication between the selected remote computer and the primary computer while the selected remote computer is being charged.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a schematic representation of a system for charging a plurality of remote computers in accordance with the present invention.

FIG. 2 is a schematic representation of a charging and synchronizing system for multiple remote computers.

### DESCRIPTION OF THE PREFERRED EMBODIMENT

The present invention is directed to a charging system and method for multiple remote computers. The system and/or method may be configured from a myriad of technologies including but not limited to microprocessors, micro-controllers, programable logic controllers (PLC's), electro-mechanical switches, integrated circuits and computers. These technologies may control separately or in combination to select and initiate the simultaneous charging of multiple remote computers, handheld computers, data collection devices and word processors.

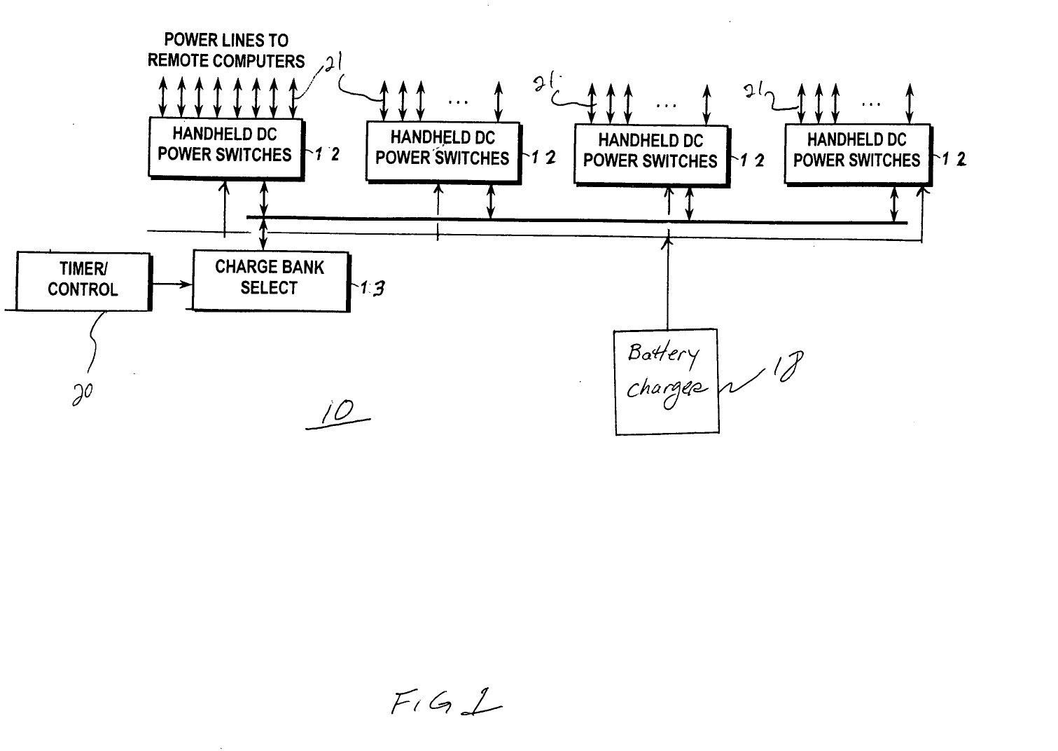

Referring now to FIG. 1, a system for charging multiple remote computers (not depicted) is denoted as numeral 10. The system 10 includes a plurality of handheld DC power switches members 12 or switching means connected to a predetermined quantity of remote computers (generally eight) such that each handheld DC power switches member 12 has substantially the same quantity of remote computers connected thereto. Initially, the entire plurality of remote computers is divided into a plurality of groups of predetermined quantities of remote computers. The system 10 further includes a charge bank select member 13 for sequentially connecting each of the handheld DC power switches members 12 to a battery charger 18 such that the battery charger 18 simultaneously charges all remote computers connected to the one handheld DC power switches member 12 that is connected to the battery charger 18. The maximum power capacity of the battery charger 18 corresponds to the group of remote computers having the largest power demand. The system 10 also includes a timer member 20 for controlling the period of time that each of the handheld DC power switches members 12 is connected to the battery charger 18.

The charge bank select member 13 selects one of a plurality of handheld DC power switches members 12. The preferred quantity of handheld DC power switches members 12 is four, but the quantity may vary depending upon the quantity of remote computers requiring charging. The handheld DC power switches member 12 has a plurality of remote computers (first group) connected thereto via independent power lines 21 that promote the charging of the remote computers. The selected handheld DC power switches member 12 receives power from a battery charger 18 and directs the power simultaneously to each of the remote computers thereby charging all connected remote computers (eight in the preferred embodiment) within a predetermined period of time (one hour in the preferred embodiment). After the one hour time period has elapsed, the charge bank select member 13 selects a second of the plurality of handheld DC power switches 12 having a plurality of remote computers (second group) connected thereto via independent power lines 21. The second handheld DC power switches member 12 ultimately charges the second group of connected remote computers during a one hour time period. The charging sequence continues for all remaining handheld DC power switches members 12 and the connected groups of remote computers.

The handheld DC power switches members 12 are implemented by using International Rectifier Corporation IRF3704 HEXFET transistors with polymer re-setable fuses or by using the preferred member, a Texas Instrument TPS2044 integrated circuit. The charge bank select member 13 may be implemented by using a CMOS CD4013 integrated circuit manufactured by OnSemiconductor Corporation, Texas Instruments Incorporated or Fairchild Semiconductor Corporation. The battery charger 18 is manufactured by Lead Year Enterprises in China and includes model TG-4201-5V.

The timer member 20 is programmed to “turn on” or enable the charge bank select member 13 at predetermined, periodic time settings. The timer member 20 ultimately allows each group of remote computers connected to a corresponding handheld DC power switches member 12 to charge simultaneously for one hour. The timer 20 is implemented by using an integrated circuit having part number CMOS CD 4060 IC, and manufactured by OnSemiconductor Corporation, Texas Instruments Incorporated or Fairchild Semiconductor Corporation.

The present invention is further directed to a charging and synchronizing system and method for multiple remote computers. The system and/or method may be configured from a myriad of technologies including but not limited to microprocessors, micro-controllers, programable logic controllers (PLC's), electro-mechanical switches, integrated circuits and computers. These technologies may control separately or in combination to select and initiate the simultaneous charging of multiple remote computers and the communication one of the remote computers being charged with a primary computer. The remote computers require small quantities of power and are generally small in physical size and include but are not limited to handheld computers, data collection devices and word processors.

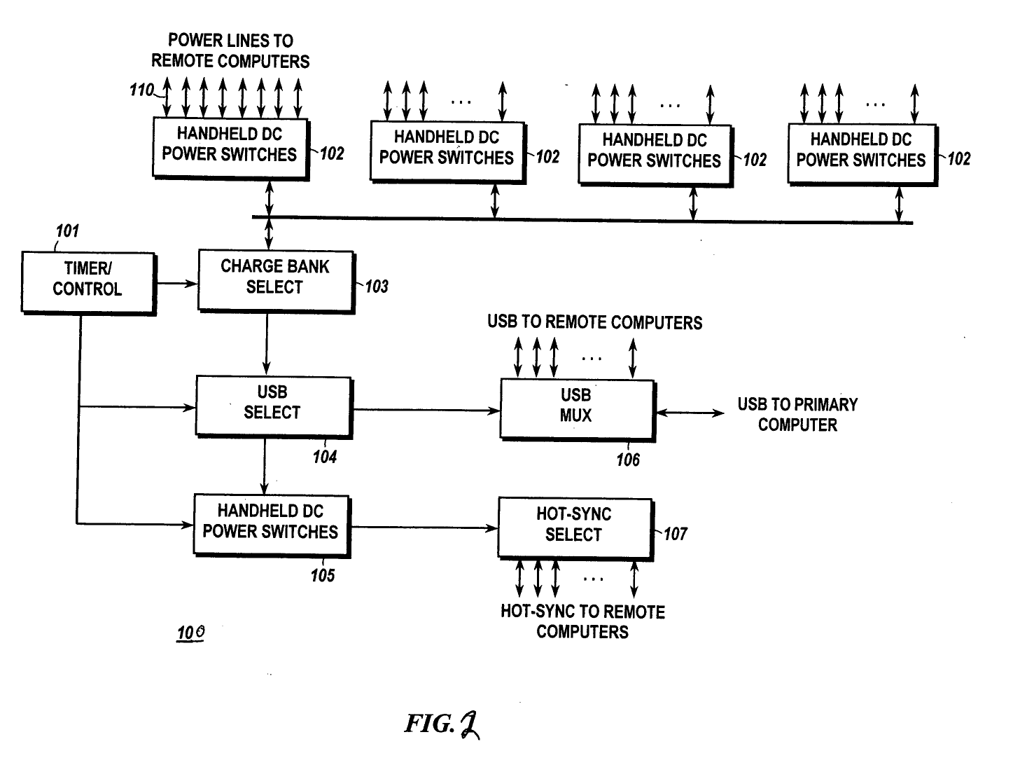

Referring now to FIG. 2, a system for charging and synchronizing multiple remote computers (not depicted) is denoted as numeral 100. The system 100 includes a timer or control member 101 that is programmed to “turn on” or enable simultaneously a charge bank select member 103, a universal serial bus (“USB”) select member 104 and handheld DC power switches 105 at predetermined, periodic time settings. The timer or control member 101 can include a variety of components including a microprocessor, computer or integrated circuit. The preferred component is an integrated circuit having part number CMOS CD4060 IC, and manufactured by OnSemiconductor Corporation, Texas Instruments Incorporated or Fairchild Semiconductor Corporation.

Once enabled by the timer 101, the charge bank select member 103 selects one of a plurality of handheld DC power switches 102. The preferred quantity of handheld DC power switches 102 for the intended use of the present system is four, but the quantity may vary with the amount of remote computers requiring charging. The handheld DC power switches member 102 has a plurality of remote computers (first group) connected thereto via independent power lines 110 that promote the charging of the batteries in the remote computers. The selected handheld DC power switches member 102 receive power from a battery charger manufactured by Lead Year Enterprises in China and identified by model number TG-4201-5V (not depicted but wired the same as the battery charger 18 depicted in FIG. 1) and directs the power simultaneously to each of the remote computers thereby charging all connected remote computers (eight in the preferred embodiment) within a predetermined period of time (one hour in the preferred embodiment). After the one hour time period has elapsed, the charge bank select member 103 selects a second of a plurality of handheld DC power switches 102 having a plurality of remote computers (second group) connected thereto via independent power lines 110. The second handheld DC power switches 102 ultimately charges the second group of connected remote computers during a one hour time period. The charging sequence continues for all remaining handheld DC power switches members 102 and the connected groups of remote computers. The charge bank select member 103 may be implemented by using a microprocessor, but the preferred member is a CMOS CD4013 integrated circuit manufactured by OnSemiconductor Corporation, Texas Instruments Incorporated or Fairchild Semiconductor Corporation. The handheld DC power switches 102 are implemented by using International Rectifier Corporation IRF3704 HEXFET transistors with polymer re-setable fuses or by using the preferred member, a Texas Instrument TPS2044 integrated circuit.

Once enabled by the timer 101, the USB select member 104 selects one of a plurality of universal serial buses that are connected to each of the remote computers and to one USB multiplexor (“MUX”) 106. The USB select 104 always selects a USB that is being charged due to an input from the charge bank select 103 that “tells” the USB select 104 which group of remote computers are simultaneously being charged. Upon selecting a USB, the USB select 104 outputs signals identifying the selected USB to the USB MUX 106 and to a handheld DC power switches member 105. Upon receiving the USB select 104 output, the USB MUX 106 “connects” the identified USB with a primary or desktop computer (not depicted) whereby the remote computer connected to the identified or selected USB is capable or enabled to communicate with the primary computer. The USB select member 104 is implemented by using a CMOS CD4013 integrated circuit manufactured by OnSemiconductor Corporation, Texas Instruments Incorporated or Fairchild Semiconductor Corporation. The USB multiplexor 106 is implemented by using a CMOS CD4051 integrated circuit manufactured by the same three corporations.

Once enabled by the timer 101 and upon receiving the USB select 104 output, the handheld DC power switches member 105 provides an amplified output signal to a hot-sync select member 107. The amplified output signal to the hot-syn select member 107 identifies the selected USB thereby “telling” the hot-syn select member 107 to initiate communication between a selected remote computer and the primary computer via independent signal lines that extend from the hot-syn select member 107 to each remote computer. The hot-syn select member 107 promotes a connection between the USB multiplexer 106 and the selected remote computer for one-eighth of an hour. The connection time corresponds to the one hour charging time that the selected handheld DC power switches member 102 charges eight remote computers which includes the selected remote computer communicating with the remote computer. After the one-eight hour has elapsed, the hot-syn select member 107 initiates communication between a second remote computer and the primary computer. The sequence continues until all eight of the remote computers connected to the selected handheld DC power switches member 102 have communicated with the primary computer. The handheld DC power switches member 105 is implemented by using a pnp transistor identified by 2N5087 and manufactured by Fairchild Semiconductor Corporation. The hot-sync select member 107 is implemented by using a CMOS CD4051 integrated circuit manufactured by OnSemiconductor Corporation, Texas Instruments Incorporated or Fairchild Semiconductor Corporation.

While the invention has been described with reference to the details of the embodiment, these detail are not intended to limit the scope of the invention as defined in the appended claims.

1. A system for charging a plurality of remote computers comprising:
a plurality of switching means, each switching means connected to a predetermined quantity of remote computers connected thereto;
means for sequentially connecting each of said switching means to a battery charger such that said battery charger simultaneously charges all remote computers connected to said switching means that is connected to said battery charger; and
means for controlling the period of time that each switching means is connected to said battery charger.

2. A method for charging a plurality of remote computers, said method comprising the steps of:
dividing the plurality of remote computers into a plurality of groups of predetermined quantities of remote computers;
connecting each group of remote computers to a switching means;
providing a maximum charging means corresponding to the group of remote computers having the largest power demand, said maximum charging means ultimately charging each group of remote computers via corresponding switching means;
selecting sequentially each switching means; and
charging simultaneously for a predetermined time period all remote computers connected to said selected switching means.

3. The method of claim 2 wherein the step of connecting each group of remote computers to a switching means includes the step of providing a handheld DC power switch.

4. The method of claim 2 wherein the step of providing a maximum charging means includes the step of calculating the power demand for each group of remote computers.

5. The method of claim 2 wherein the step of selecting sequentially each switching means includes the step of providing a charge bank select member.

6. The method of claim 2 wherein the step of charging simultaneously for a predetermined time period all remote computers connected to said selected switching means includes the step of providing an integrated circuit for controlling the charging period.

7. Charging and synchronizing system for multiple remote computers comprising:
means for selecting for charging a plurality of remote computers;
means for charging said plurality of remote computers;
means for selecting one of a plurality of universal serial buses, each of said plurality of universal serial buses being connected to a remote computer;
means for connecting said one selected universal serial bus to a primary computer whereby a selected remote computer connected to said selected universal serial bus is capable of communicating with the primary computer;
means for initiating communication between the selected remote computer and the primary computer; and
means for promoting the communication between the selected remote computer and the primary computer while the selected remote computer is being charged.

8. The system of claim 7 wherein said plurality of remote computers includes eight remote computers.

9. The system of claim 7 wherein said selecting means for charging a plurality of remote computers includes a microprocessor.

10. The system of claim 8 wherein said microprocessor is programmed to cause said plurality of remote computers to charge for one hour.

11. The system of claim 7 wherein said plurality of remote computers is one group of a plurality of groups, each group of said plurality of groups having a plurality of remote computers.

12. The system of claim 11 wherein said plurality of groups constitute a predetermined quantity of remote computers.

13. The system of claim 12 wherein said predetermined quantity of remote computers are ultimately charged by sequentially charging each group of said plurality of groups via group select means, said group select means causing each of said remote computers in a selected group to charge simultaneously for a predetermined time period.

14. The system of claim 7 wherein said promoting means includes a timer.

15. The system of claim 14 wherein said timer is implemented by a microprocessor.

16. The system of claim 14 wherein said timer is implemented by an integrated circuit

17. The system of claim 7 wherein said charging means includes a battery charger and a power switch cooperatively coupled such that a single battery charger will charge a selected group of remote computers.

18. The system of claim 7 wherein said selecting means for one of a plurality of universal serial buses includes a microprocessor.

19. The system of claim 7 wherein said selecting means for one of a plurality of universal serial buses includes an integrated circuit.

20. The system of claim 14 wherein said timer includes means for periodically selecting one of a plurality of universal serial buses while a corresponding remote computer is being charged.

21. The system of claim 7 wherein said means for initiating communication includes means for periodically initiating communication while a corresponding remote computer is being charged.

22. The system of claim 7 wherein said means for connecting one selected universal serial bus to a primary computer includes multiplexor means.

23. The system of claim 7 wherein said initiating means includes amplifier means and selector means cooperatively coupled such that a signal from said amplifier to said selector means will cause one of a plurality of remote computers connected to said selector means to communicate with said primary computer while said one remote computer is being charged.

24. A method for charging and synchronizing multiple remote computers, said method comprising the steps of:
sequentially selecting for charging one group of remote computers from a plurality of groups of remote computers, each group of said plurality of groups including a plurality of remote computers to be charged simultaneously;
selecting a universal serial bus connected to a remote computer in said selected group of remote computers being charged;
connecting said selected universal serial bus to a primary computer whereby the remote computer connected to said selected universal serial bus is capable of communicating with the primary computer; and
initiating communication between the remote computer connected to said selected universal serial bus and the primary computer.

25. The method of claim 24 wherein the step of sequentially selecting for charging one group of remote computers includes the step of periodically selecting for charging said one group of remote computers.

26. A system for charging and synchronizing multiple handheld computers comprising:
means for sequentially selecting for charging one group of handheld computers from a plurality of groups of handheld computers, each group of said plurality of groups includes a plurality of handheld computers to be charged simultaneously;
means for selecting a universal serial bus connected to a handheld computer in said selected group of handheld computers being charged;
means for connecting said selected universal serial bus to a desktop computer whereby the handheld computer connected to said selected universal serial bus is capable of communicating with the desktop computer; and
means for initiating communication between the handheld computer connected to said selected universal serial bus and the desktop computer.
